(19) United States
(12) Patent Application Publication
(10) Pub. No.: US 2021/0358267 A1
(43) Pub. Date: Nov. 18, 2021

(54) OPERATION SYSTEM BASED ON MEMBERSHIP LEVEL AND METHOD THEREOF

(71) Applicant: Jie Hang Network Technology Ltd., Taipei City (TW)

(72) Inventors: Chia Hui PAN, Taipei City (TW); Chien Wei HUANG, Taipei City (TW)

(73) Assignee: Jie Hang Network Technology, Ltd.

(21) Appl. No.: 17/091,198

(22) Filed: Nov. 6, 2020

(30) Foreign Application Priority Data
May 12, 2020 (TW) 109115772

(51) Int. Cl. G07F 17/32

(52) U.S. Cl. CPC G07F 17/3239; G07F 17/3223

(57) ABSTRACT

An operation system based on membership level is provided, comprising: a database; a computer device connected to the database, the computer device receiving a member data and setting the member data to a zero-th membership level, the computer device searching in the database for a plurality of (N+1)th-level sub-member data related to the N-th level sub-member data, and setting the (N+1)th-level sub-member data to (N+1)th membership level; and a display device, using the member data as a center, displaying the member data, the first membership level, the second membership level to the (N+1)th membership level, where N being an integer greater than or equal to two. Moreover, an operation method based on membership level is also provided.

### CROSS-REFERENCE TO RELATED APPLICATION

This application claims the priority of Taiwanese patent application No. 109115772, filed on May 12, 2020, which is incorporated herewith by reference.

### BACKGROUND OF THE INVENTION

### 1. Field of the Invention

The present invention relates generally to an operation system, and more particularly, to an operation system and method for analyzing and calculating the levels of a plurality of members, and assigning these members new attributes for arrangement.

### 2. The Prior Arts

The traditional membership level operations are usually based on the order from high to low membership levels. However, in such an operation system, because of the lack of a systematic and intuitive operation approach, the result is often presented as a complicated tree-like organization chart. Therefore, it is difficult for the administrator to manage all members, and is also difficult for members themselves to clearly know at which level of operation they are at, nor do they know how many people are below them, which makes it impossible to pay attention to these members who are below them.

For example, in a traditional tree-like organization structure, a member cannot easily and quickly know how many people are at one level below them, nor can the member quickly know how many people are at the second, third to N-th level, which prevents the member from making work arrangements for members at all levels, so naturally it is impossible to set up a reward system for each level according to the number of people in each level.

### SUMMARY OF THE INVENTION

As seen from the above-mentioned prior art, it is currently impossible to provide a systematic and intuitive membership level operation system, resulting in the inability to effectively manage members at various levels.

Therefore, the primary objective of the present invention is to provide a systematic and intuitive membership level operation system to flatten the complex tree-like organization chart.

For achieving the foregoing objectives, the present invention provides an operation system based on membership level, comprising: a database; a computer device connected to the database, the computer device receiving a member data and setting the member data to a zero-th membership level, the computer device further comprising: at least an analysis comparison module, for searching in the database for a plurality of first-level sub-member data associated with the member data, and setting the first-level sub-member data as a first membership level; the at least an analysis comparison module searching in the database for a plurality of second-level sub-member data associated with the first-level sub-member data, and setting the second-level sub-member data as a second membership level; and so on, the at least an analysis comparison module searching in the database for a plurality of (N+1)th-level sub-member data related to the N-th level sub-member data, and setting the (N+1)th-level sub-member data to (N+1)th membership level; and a display device, using the member data as a center, displaying the member data, the first membership level, the second membership level to the (N+1)th membership level, where N being an integer greater than or equal to two.

Furthermore, the computer device further comprises a classification module, the computer device receives a new member data and a code scanned by a new member, the classification module determines that the code belongs to the M-th membership level, and the new member data is classified to the (M+1)-th membership level, where M is any number greater than or equal to one.

In addition, the operation system based on membership levels of the present invention further comprises a plurality of first computer devices, a plurality of second computer devices, . . . , and a plurality of M-th computer devices, and the first computer devices scan the zero-th code representing the member data on the computer device to generate the first-level sub-member data, and the second computer devices scan the first-level code representing the first-level sub-member data on the first computer device to generate the second-level sub-member data, and so on, the M-th computer devices scan the (M−1)th-level code representing the (M−1)th-level sub-member data on the (M−1)th computer devices to generate the M-th level sub-member data, and the first-level sub-member data, the second-level sub-member data, . . . , and the M-th sub-member data are uploaded to and stored in the database, where M is any integer greater than or equal to three.

Preferably, when the display device displays the first membership level, the second membership level, or the (N+1)th membership level, the display device also simultaneously displays the first-level sub-member data in the first membership level, the second-level sub-member data in the second membership level, or the (N+1)th-level sub-member data in the (N+1)th membership level.

Preferably, the computer device further comprises a sorting module, the sorting module sorts the first-level sub-member data, the second-level sub-member data, . . . , and the (N+1)th-level sub-member data according to, in the current month, an amount of bet made by the member, an amount of profit made by the member, a total transaction amount of the member, a number of orders placed by the member, and an amount of added value of the member, and a weight given to the amount of bet made by the member is greater than the amount of profit made by the member, a weight given to the amount of profit made by the member is greater than the total transaction amount of the member, a weight given to the total transaction amount of the member is greater than the number of orders placed by the member, and a weight given to the number of orders placed the member is greater than the amount of value added by the member.

Furthermore, the present invention also provides an operation method based on membership level, wherein a computer device executes the following steps to analyze and compare a member data. The computer device can be connected to other computer devices or a database via a network for data connection, and the method includes the following steps: providing the member data to the computer device, and the computer device sets the member data to a zero-th membership level; the computer device searches the database for plural numbers associated with the member data First-level sub-member data, and set the first-level sub-member data as a first-level member level; the computer device searches the database for a plurality of second-level sub-member data associated with the first-level sub-member data Level sub-member data, and set the second-level sub-member data as the second-level member level; and so on, the computer device searches the database for a plurality of N-ths associated with the N-th sub-member data +1-level sub-member data, and set the (N+1)th-level sub-member data as an (N+1)-level member level; and the computer device displays the member data and the first membership level, the second membership level, . . . , the (N+1)th membership level are displayed on a display device together with the member data, where N is any number greater than or equal to two.

Furthermore, the operation method based on membership level of the present invention further comprises the following steps: a new member scans a code so that a new member data is provided to the computer device, and the computer device receives the code and the new member data, determines that the code belongs to the M-th membership level, and classifies the new member data to the (M+1)th membership level, where M is any integer greater than or equal to one.

Preferably, a plurality of first-level sub-members generate the plurality of first-level sub-member data by scanning the zero-th code representing the member data, a plurality of second-level sub-members generate the plurality of second-level sub-member data by scanning the first-level code representing the first-level sub-member data, and so on, and a plurality of (N+1)th-level sub-members generate the plurality of (N+1)th-level sub-member data by scanning the N-th-level code representing the N-th-level sub-member data.

Preferably, when the first membership level, the second membership level, or the (N+1)th membership level is clicked on the display device, the display device displays the first-level sub-member data included in the first membership level, the second-level sub-member data included in the second membership level, or the (N+1)th-level sub-member data included in the (N+1)th membership level.

Preferably, the first-level sub-member data, the second-level sub-member data, . . . , and the (N+1)th-level sub-member data are sorted according to the amount of bet made by the member, the amount of profit made by the member, and the total number of transactions made by the member, the number of orders placed by the member, and the amount of added value of the member in the current month, and weight given to the amount of bet made by the member is greater than the amount of profit made by the member, the weight given to the amount of profit made by the member is greater than the total transaction amount of the member, the weight given to the total transaction amount of the member is greater than the number of orders placed by the member, and the weight given to the number of orders placed the member is greater than the amount of value added by the member.

In the present invention, a new type of flattening operation can be performed on the member data of different levels in the database by the computer device, and new management attributes can be assigned to the member data of the same level. As such, the complex tree structure can be flattened, which allows users to systematically and intuitively obtain all member data below themselves, and allows users to operate quickly and easily to effectively manage members at all levels.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic structural view of an operation system based on membership level according to an embodiment of the present invention.

FIG. 2 is a schematic view of the operation level of the operation system based on membership level according to an embodiment of the present invention.

FIG. 3 is a schematic diagram of an operation screen of the operation system based on membership level according to an embodiment of the present invention.

FIG. 4 is a schematic structural view of an operation system based on membership level according to another embodiment of the present invention.

FIG. 5 is a schematic structural view of an operation system based on membership level according to yet another embodiment of the present invention.

FIG. 6 is a flowchart of an operation system based on membership level according to an embodiment of the present invention.

FIG. 7 is a flowchart of an operation system based on membership level according to another embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

### First Embodiment

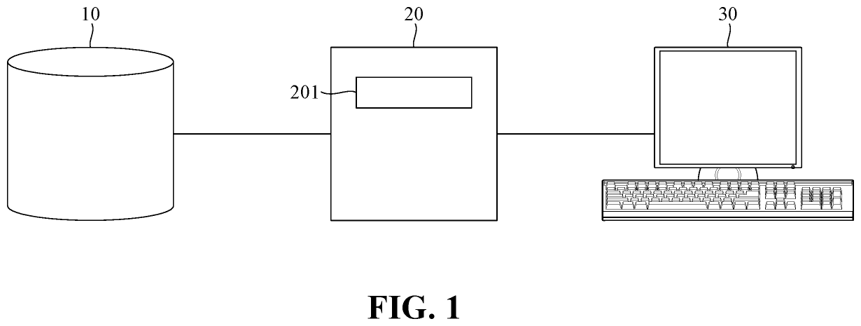

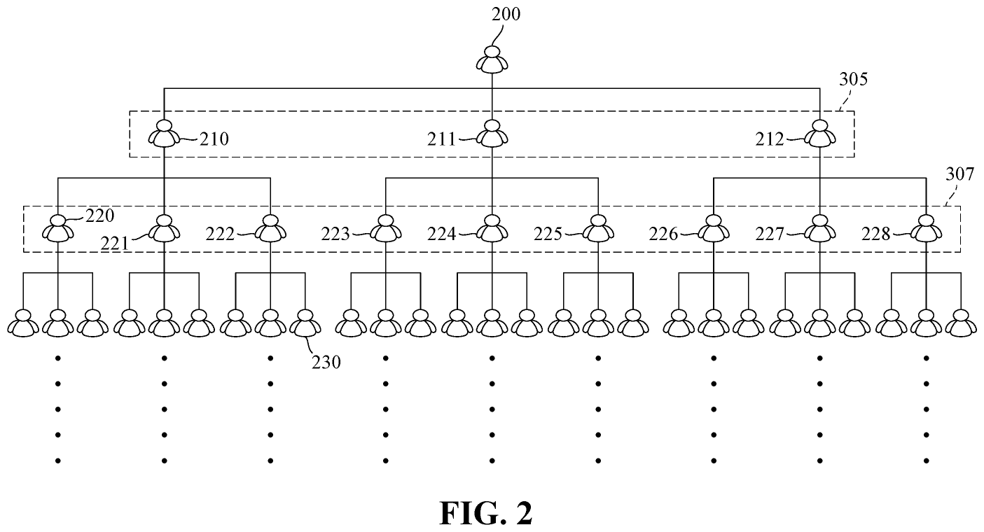

FIG. 1 is a schematic structural view of an operation system based on membership level according to an embodiment of the present invention; FIG. 2 is a schematic view of the operation level of the operation system based on membership level according to an embodiment of the present invention. As shown in FIG. 1 and FIG. 2, in an embodiment of the present invention, an operation system based on membership level comprises: 1 database 10, a computer device 20 and a display device 30. The database 10 stores a plurality of member data. The computer device 20 is connected to the database 10, and the computer device 20 receives a member data 200 and sets the member data 200 as a zero-th membership level. In an embodiment of the present invention, the member data 200 may be the user's own data. The computer device 20 can also be called a member computer device, and can be a background management platform, a smart device, and so on, and the display device 30 can be a display screen of a smart mobile device.

Specifically, the computer device 20 includes at least an analysis comparison module 201. The analysis comparison module 201 searches the database 10 for a plurality of first-level sub-member data associated with the member data 200, such as the first-level sub-member data shown in FIG. 2, the first-level sub-member data 210, the first-level sub-member data 211, and the first-level sub-member data 212. The analysis comparison module 201 will set the first-level sub-member data 210-212 to the first membership level 305; then, the analysis comparison module 201 searches the database 10 for a plurality of second-level sub-member data associated with the first-level sub-member data 210-212, such as the second-level sub-member data 220-228 shown in FIG. 2, and the second-level sub-member data 220-228 are set to the second membership level 307, and so on. The analysis comparison module 201 will search the database 10 for a plurality of (N+1)th-level sub-member data associated with the N-th-level sub-member data, and the (N+1)th-level sub-member data is set to the (N+1)th membership level, where N is any integer greater than or equal to two.

For example, when N is three, the analysis comparison module 201 searches the database 10 for a plurality of fourth-level sub-member data associated with the third-level sub-member data, and sets the fourth-level sub-member data to the fourth membership level.

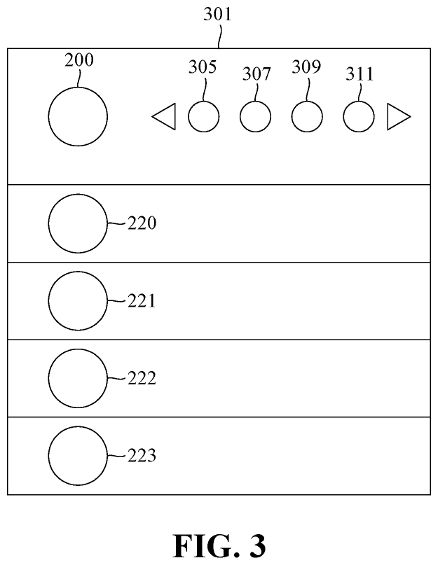

FIG. 3 is a schematic diagram of an operation screen of the operation system based on membership level according to an embodiment of the present invention. Referring to FIGS. 1-3, the display device 30 will center on the member data 200, and display the member 200 representing the zero membership level, the first membership level 305, the second membership level 307, . . . , the (N+1)th membership level on the display screen 301, where N is any integer greater than or equal to two, such as the third membership level 309, the fourth membership level 311, and so on.

Furthermore, when the display device 30 displays the first membership level 305, the second membership level 307, or the (N+1)th membership level, the display device 30 can simultaneously display a plurality of first-level sub-member data in the first membership level 305, a plurality of second-level sub-member data in the second membership level 307, or a plurality of (N+1)th-level sub-member data in the (N+1)th membership level. For example, FIG. 3 shows that the second-level sub-member data 220-228 are displayed simultaneously. It should be understood that the plurality of sub-member data shown on the display device 30 will be adjusted according to the selection of different levels of membership. Furthermore, the user can select different membership levels by scrolling the display screen 301 to learn a plurality of member data of different levels.

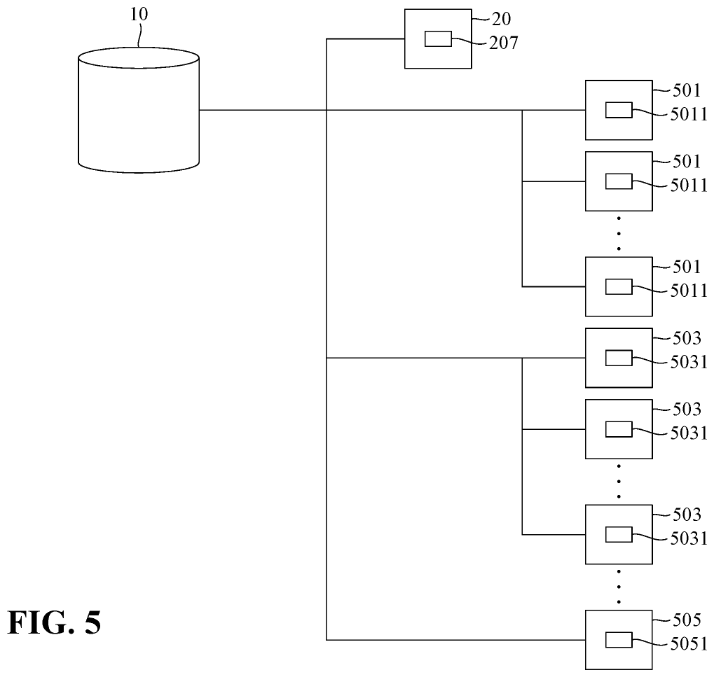

Moreover, FIG. 5 is a schematic structural view of an operation system based on membership level according to yet another embodiment of the present invention. Referring to FIGS. 2 and 5, in an embodiment of the present invention, the operation system based on membership levels further includes a plurality of first computer devices 501, a plurality of second computer devices 503, . . . , and a plurality of M-th computer devices 505. The first computer device 501 is to scan the zero-th code 207 on the computer device 20 representing the member data 200 to generate the first-level sub-member data 210-212, the second computer device 503 scans the first-level code 5011 representing the first-level sub-member data 210-212 on the first computer device 501 to generate the second-level sub-member data 220-228. The third computer device scans the second-level code 5031 representing the second-level sub-member data 220-228 on the second computer device 503 to generate a plurality of the third-level sub-member data, and so on. The M-th computer device 505 scans the (M−1) level code representing the (M−1)th-level sub-member data on the (M−1)th computer device to generate a plurality of M-th-level sub-member data. At the same time, the M-th computer device 505 will contain an M-level code 5051, and the first-level sub-member data 210-212, the second-level sub-member data 220-228, . . . , the M-th-level sub-member data will be uploaded and stored in the database 10, where M is any integer greater than or equal to three.

For example, the third computer device scans the second-level code 5031 representing the second-level sub-member data 220-228 on the second computer device to generate a plurality of third-level sub-member data; or, the fourth computer device scans the third-level code representing the third-level sub-member data on the third computer device to generate a plurality of fourth-level sub-member data.

Furthermore, the operation system based on membership level of the present invention will set the user to the zero-th membership level, and sort the members of subsequent levels associated with the user. Therefore, the operation system based on membership level of the present invention is applicable members at various levels, and the members at low levels will not be excluded from using the system. In addition, the operation system based on membership level of the present invention can be applied to any investment trading platform, direct selling platform, gaming platform or other similar platforms.

### Second Embodiment

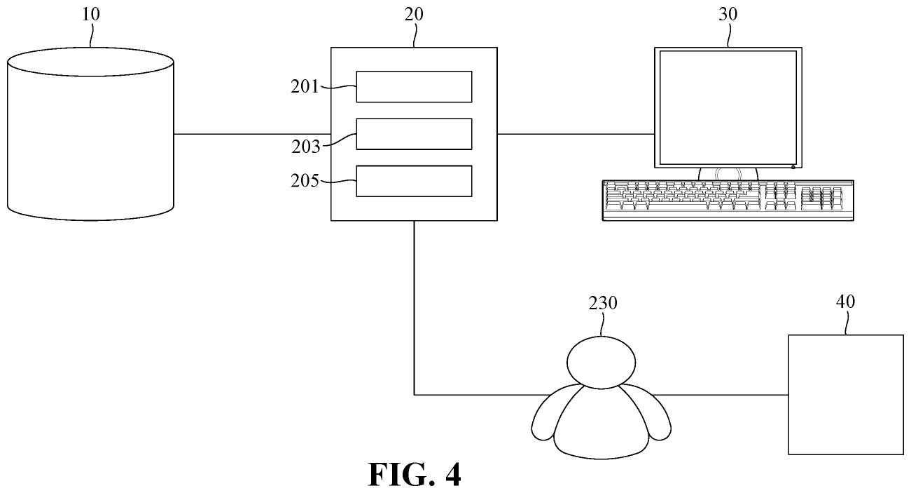

FIG. 4 is a schematic structural view of an operation system based on membership level according to another embodiment of the present invention. As shown in FIGS. 2 and 4, in another embodiment of the present invention, the computer device 20 further includes a classification module 203, when the computer device 20 receives a new member data and a new code scanned by a new member using a new member computer device, the classification module 203 will determine that the code belongs to the M-th membership level, and classify the new member data to the (M+1)th membership level, where M is any integer greater than or equal to one.

For example, as shown in FIG. 2 and FIG. 4, the new member data 230 is generated by the new member computer device scanning the code 40 representing the second-level sub-member data 222, and the new member computer device sends the new member data 230 and code 40 to the computer device 20. When the computer device 20 receives the new member data 230 and code 40, the classification module 203 will determine that the code 40 representing the second-level sub-member data 222 belongs to the second membership level 307, the classification module 203 then classifies the new member data 230 to the third membership level; wherein, the code 40 can be a QR code, a two-dimensional bar code or other types of codes.

As seen in the present embodiment, when new member data is added, the operation system based on membership level of the present invention will automatically determine the new member data is generated by scanning the code representing which membership level, and the new member data is then automatically classified to the next level of membership. Therefore, the operation system based on membership level of the present invention will not cause mixed data due to new members, but rather systematically classify new member data.

### Third Embodiment

Referring to FIGS. 2-4 again, in another embodiment of the present invention, the computer device 20 further includes a sorting module 205, the sorting module 205 sorts the first-level sub-member data 210-212, the second-level sub-member data 220-228, . . . , and the (N+1)th-level sub-member data according to, in the current month, an amount of bet made by the member, an amount of profit made by the member, a total transaction amount of the member, a number of orders placed by the member, and an amount of added value of the member, and a weight given to the amount of bet made by the member is greater than the amount of profit made by the member, a weight given to the amount of profit made by the member is greater than the total transaction amount of the member, a weight given to the total transaction amount of the member is greater than the number of orders placed by the member, and a weight given to the number of orders placed the member is greater than the amount of value added by the member. At the same time, the sorted member data will be simultaneously displayed on the display screen 301 of the display device 30.

For example, as shown in FIG. 3, the sorting module 205 sorts the second-level sub-member data 220-223 according to the aforementioned principles. If the second-level sub-member data 220 and the second-level sub-member data 221 have the same amount of bet in the current month, the sorting will be based on the time of joining of the second-level sub-member data 220 and the second-level sub-member data 221 respectively. In addition, in other embodiments of the present invention, the operation system based on membership level can display a filter condition button on the display screen 301, and the user can click on the filter condition button to individually target the monthly amount of bet made by the member, the amount of profit, the total transaction amount of the member, the number of orders placed by the member, or the amount of added value of the member for comparison.

### Fourth Embodiment

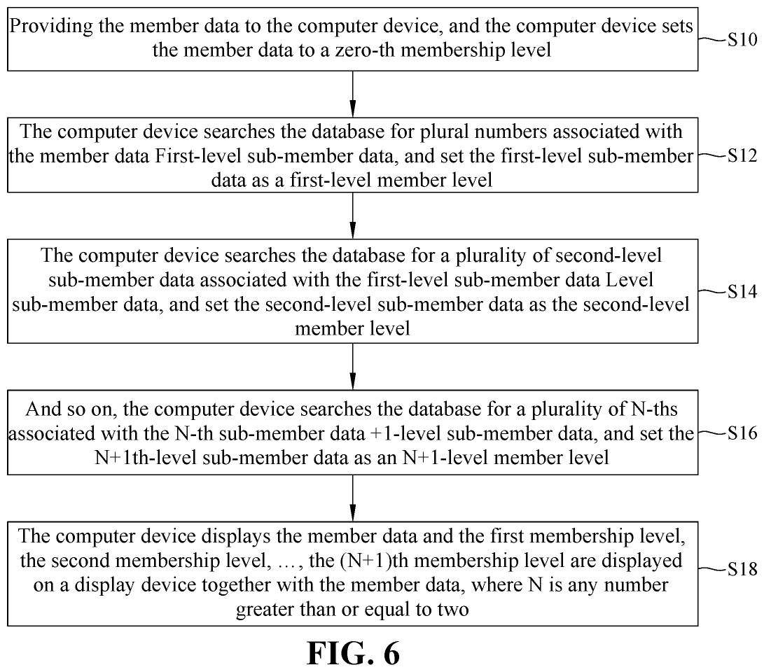

Moreover, the present invention also provides an operation method for membership levels. FIG. 6 is a flowchart for describing an operation method for membership levels of an embodiment of the present invention. Refer to FIGS. 1-3 and FIG. 6. The operation method for membership levels of the present invention is that a computer device 20 executes the following steps to analyze and compare a member data 200. The computer device 20 can be connected to other computers or a database 10 via the network for data connection. The method of the present invention includes steps S10 to S18. Step S10 is to provide the member data 200 to the computer device 20, and the computer device 20 sets the member data 200 to the zero-th membership level. In Step S12, the computer device 20 searches the database 10 for a plurality of first-level sub-member data 210-212 associated with the member data 20, and sets the first-level sub-member data 210-212 as a first membership level 305; Step S14: the computer device 20 searches the database 10 for a plurality of second-level sub-member data 220-228 that are associated with the first-level sub-member data 210-212, and the second-level sub-member data 220-228 are set as the second membership level 307; Step S16: repeating the aforementioned process until that the computer device 20 searches the database 10 for a plurality of (N+1)th-level sub-member data related to the N-th-level sub-member data, and the (N+1)th-level sub-member data are set to the (N+1)th membership level; and in Step S18, using the member data 200 as a center, the computer device 20 displays the first membership level 305, the second membership level 307, . . . , and the (N+1)th membership level on a display device 300 along with the member data 200, where N is an integer greater than or equal to two.

For example, in step S16, when N is two, the computer device 20 searches the database 10 for a plurality of third-level sub-member data associated with the second-level sub-member data 220-228, and sets the third-level sub-member data to the third membership level.

Wherein, in step S12 to step S16, a plurality of first-level sub-members generate the first-level sub-member data 210-212 by scanning the zero-th code representing the member data 200, a plurality of second-level sub-members generate the second-level sub-member data 220-228 by scanning the first-level code representing the first-level sub-member data 210-212, . . . , and a plurality of (N+1)th-level sub-members generate the (N+1)th-level sub-member data by scanning the N-th-level code representing the N-th-level sub-member data, where N is any integer greater than or equal to two. For example, when N is two, a plurality of third-level sub-members generates the third-level sub-member data by scanning the second-level code representing the second-level sub-member data 220-228.

Furthermore, when the first membership level 305, the second membership level 307, or the (N+1)th membership level is clicked on the display screen 301 of the display device 30, the display 30 will display the first-level sub-member data 210-212 included in the first membership level 305, the second-level sub-member data 220-228 included in the second membership level 307, or the (N+1)th-level sub-member data included in the (N+1)th membership level, wherein, N is any integer greater than or equal to two.

Furthermore, the first-level sub-member data 210-212, the second-level sub-member data 220-228, . . . , and the (N+1)th-level sub-member data are sorted according to, in the current month, an amount of bet made by the member, an amount of profit made by the member, a total transaction amount of the member, a number of orders placed by the member, and an amount of added value of the member, and a weight given to the amount of bet made by the member is greater than the amount of profit made by the member, a weight given to the amount of profit made by the member is greater than the total transaction amount of the member, a weight given to the total transaction amount of the member is greater than the number of orders placed by the member, and a weight given to the number of orders placed the member is greater than the amount of value added by the member. At the same time, the sorted member data will be simultaneously displayed on the display screen 301 of the display device 30, wherein N is any integer greater than or equal to two.

### Fifth Embodiment

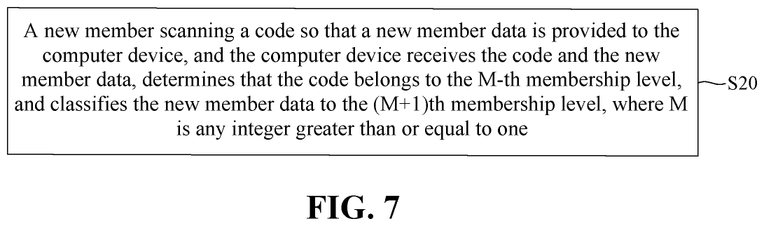

FIG. 7 is a flowchart of an operation system based on membership level according to another embodiment of the present invention. Refer to FIG. 2, FIG. 4 and FIG. 7, in another embodiment of the present invention, the operation method further includes a step S20, wherein in step S20, a new member using a new member computer device to scan a code 40 to make a new member data 230 provided to the computer device 20. The computer device 20 receives the code 40 and the new member data 230, and determines that the code belongs to the M-th membership level, and classifies the new member data to the (M+1)th membership level, wherein M is any integer greater than or equal to one.

For example, the new member data 230 is generated by the new member computer device scanning the code 40 representing the member data 222, and the new member computer device transmits the new member data 230 and the code 40 to the computer device 20. When the computer device 20 receives the new member data 230 and the code 40, the computer device 20 will determine that the code 40 representing the member data 222 belongs to the second membership level 307, and the classification module 203 will classify the new member data 230 to the third membership Level, wherein, the code 40 can be a QR code, a two-dimensional bar code or other types of codes.

The present invention uses a computer device to perform a new operation to flatten the member data of different levels in the database, and assigns new management attributes to the member data belonging to the same level. As such, the operation system based on membership level can be systematic and intuitive to display the user's own data and all the member data of levels below the user together, so that the user can quickly and easily operate to understand all the member data of the levels below them and make different arrangements for all members. In summary, the present invention can provide assistance to any industry that needs to operate and manage members, such as, any type of investment trading platform, direct selling platform, gaming platform or other similar platforms.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An operation system based on membership level, comprising:
a database;
a computer device connected to the database, the computer device receiving a member data and setting the member data to a zero-th membership level, the computer device further comprising:
at least an analysis comparison module, for searching in the database for a plurality of first-level sub-member data associated with the member data, and setting the first-level sub-member data as a first membership level; the at least an analysis comparison module searching in the database for a plurality of second-level sub-member data associated with the first-level sub-member data, and setting the second-level sub-member data as a second membership level; and so on, the at least an analysis comparison module searching in the database for a plurality of (N+1)th-level sub-member data related to the N-th level sub-member data, and setting the (N+1)th-level sub-member data to (N+1)th membership level; and
a display device, using the member data as a center, displaying the member data, the first membership level, the second membership level to the (N+1)th membership level, where N being an integer greater than or equal to two.

2. The operation system according to claim 1, wherein the computer device further comprises a classification module, the computer device receives a new member data and a code scanned by a new member, the classification module determines that the code belongs to the M-th membership level, and the new member data is classified to the (M+1)-th membership level, where M is any number greater than or equal to one.

3. The operation system according to claim 1, wherein the operation system based on membership levels of the present invention further comprises a plurality of first computer devices, a plurality of second computer devices, . . . , and a plurality of M-th computer devices, and the first computer devices scan the zero-th code representing the member data on the computer device to generate the first-level sub-member data, and the second computer devices scan the first-level code representing the first-level sub-member data on the first computer device to generate the second-level sub-member data, and so on, the M-th computer devices scan the (M−1)th-level code representing the (M−1)th-level sub-member data on the (M−1)th computer devices to generate the M-th level sub-member data, and the first-level sub-member data, the second-level sub-member data, . . . , and the M-th sub-member data are uploaded to and stored in the database, where M is any integer greater than or equal to three.

4. The operation system according to claim 1, wherein when the display device displays the first membership level, the second membership level, or the (N+1)th membership level, the display device also simultaneously displays the first-level sub-member data in the first membership level, the second-level sub-member data in the second membership level, or the (N+1)th-level sub-member data in the (N+1)th membership level.

5. The operation system according to claim 4, wherein the computer device further comprises a sorting module, the sorting module sorts the first-level sub-member data, the second-level sub-member data, . . . , and the (N+1)th-level sub-member data according to, in the current month, an amount of bet made by the member, an amount of profit made by the member, a total transaction amount of the member, a number of orders placed by the member, and an amount of added value of the member, and a weight given to the amount of bet made by the member is greater than the amount of profit made by the member, a weight given to the amount of profit made by the member is greater than the total transaction amount of the member, a weight given to the total transaction amount of the member is greater than the number of orders placed by the member, and a weight given to the number of orders placed the member is greater than the amount of value added by the member.

6. An operation method based on membership level, executed by a computer device to analyze and compare a member data, the computer device being connected to other computer devices or a database via a network for data connection, the operation method comprising the following steps:
providing the member data to the computer device, and the computer device sets the member data to a zero-th membership level;
the computer device searches the database for plural numbers associated with the member data First-level sub-member data, and set the first-level sub-member data as a first-level member level;
the computer device searches the database for a plurality of second-level sub-member data associated with the first-level sub-member data Level sub-member data, and set the second-level sub-member data as the second-level member level;
and so on, the computer device searches the database for a plurality of N-ths associated with the N-th sub-member data +1-level sub-member data, and set the (N+1)th-level sub-member data as an (N+1)-level member level; and
the computer device displays the member data and the first membership level, the second membership level, . . . , the (N+1)th membership level are displayed on a display device together with the member data, where N is any number greater than or equal to two.

7. The operation method according to claim 6, wherein the operation method based on membership level of the present invention further comprises the following steps: a new member scans a code so that a new member data is provided to the computer device, and the computer device receives the code and the new member data, determines that the code belongs to the M-th membership level, and classifies the new member data to the (M+1)th membership level, where M is any integer greater than or equal to one.

8. The operation method according to claim 6, wherein a plurality of first-level sub-members generate the plurality of first-level sub-member data by scanning the zero-th code representing the member data, a plurality of second-level sub-members generate the plurality of second-level sub-member data by scanning the first-level code representing the first-level sub-member data, and so on, and a plurality of (N+1)th-level sub-members generate the plurality of (N+1)th-level sub-member data by scanning the N-th-level code representing the N-th -level sub-member data.

9. The operation method according to claim 6, wherein when the first membership level, the second membership level, or the (N+1)th membership level is clicked on the display device, the display device displays the first-level sub-member data included in the first membership level, the second-level sub-member data included in the second membership level, or the (N+1)th-level sub-member data included in the (N+1)th membership level.

10. The operation method according to claim 6, wherein the first-level sub-member data, the second-level sub-member data, . . . , and the (N+1)th-level sub-member data are sorted according to the amount of bet made by the member, the amount of profit made by the member, and the total number of transactions made by the member, the number of orders placed by the member, and the amount of added value of the member in the current month, and weight given to the amount of bet made by the member is greater than the amount of profit made by the member, the weight given to the amount of profit made by the member is greater than the total transaction amount of the member, the weight given to the total transaction amount of the member is greater than the number of orders placed by the member, and the weight given to the number of orders placed the member is greater than the amount of value added by the member.
